(19) United States
(12) Patent Application Publication
(10) Pub. No.: US 2014/0246909 A1
(43) Pub. Date: Sep. 4, 2014

(54) SYSTEM AND METHOD FOR BALANCING SUPPLY AND DEMAND OF ENERGY ON AN ELECTRICAL GRID

(71) Applicant: Adam A. Todorski, Cropseyville, NY (US)

(72) Inventor: Adam A. Todorski, Cropseyville, NY (US)

(21) Appl. No.: 13/783,784

(22) Filed: Mar. 4, 2013

(51) Int. Cl. H02J 3/00

(52) U.S. Cl. CPC H02J 3/00
USPC 307/31

(57) ABSTRACT

Systems and methods for balancing power on an electrical power grid are provided. Demand-side equipment, such as industrial heaters, refrigeration units, and freezers are adjusted to help balance the electrical grid. The power utility that operates the local electric grid (or other external entity) requests real time changes in electrical consumption by specifying specific levels of electrical demand in units of energy (watts). A device control system translates the requested energy level to thermal set points in thermal devices (heaters, air conditioners, freezers, chillers, and the like) such as degrees Fahrenheit or Celsius, to the specific pieces of equipment most likely to most quickly achieve and sustain this level of energy consumption to reduce or increase the supply of available energy as needed.

### FIELD OF THE INVENTION

The present invention relates generally to energy management, and more particularly, to systems and methods of balancing supply and demand of energy on an electrical grid.

### BACKGROUND

Electrical power grids suffer from cyclic variation in demand that requires the electric power generation resources to vary their output, which is neither efficient or cost effective for many types of generators. Also, the generating capacity must be constructed to meet the peak power demand times, even though this top 10% of demand may exist for only a few hours each day. It is therefore desirable to have improved systems and methods for handling the fluctuating demand and supply of electrical energy on an electric power grid.

### SUMMARY OF THE INVENTION

Embodiments of the present invention provide systems and methods for balancing power on an electrical grid, by adjusting demand-side equipment.

Embodiments of the present invention provide a method for managing available power in an electrical power grid, comprising: receiving a power adjustment request, making an adjustment to operating parameters of one or more thermal devices located in one or more facilities, in response to the power adjustment request, and disbursing a remuneration to the one or more facilities where at least one thermal device was adjusted.

Other embodiments of the present invention provide a method for managing available power in an electrical power grid, comprising: receiving a power adjustment request, making an adjustment to operating parameters of one or more thermal devices located in one or more facilities, in response to the power adjustment request, computing an adjustment duration period for each thermal device belonging to each facility, and computing a remuneration value based on the adjustment duration period.

Other embodiments of the present invention provide a system for managing available power in an electrical power grid, comprising one or more processors coupled to non-transitory memory comprising machine instructions, that when executed by the one or more processors, perform functions of: receiving a power adjustment request, making one or adjustments to operating parameters of one or more thermal devices located in one or more facilities, in response to the power adjustment request, and disbursing a remuneration to the one or more facilities in response to each facility where at least one thermal device was adjusted.

### BRIEF DESCRIPTION OF THE DRAWINGS

FIG. 1 is a system in accordance with embodiments of the present invention.

FIG. 2 is exemplary data for embodiments of the present invention.

FIG. 3 is a flowchart indicating process steps for adding a thermal device to a queue.

FIG. 4 is a flowchart indicating process steps for removing a thermal device from a queue.

FIG. 5 is a flowchart indicating process steps for performing settlement.

FIG. 6 is a block architecture diagram for a system in accordance with embodiments of the present invention.

### DETAILED DESCRIPTION

Embodiments of the present invention provide systems and methods for balancing power on an electrical power grid, by adjusting demand-side equipment. The power utility that operates the local electric grid (or other external entity) requests real time changes in electrical consumption by specifying specific levels of electrical demand in units of energy (watts). This request is referred to as a power adjustment request and may be implemented with a traditional Automatic Generator Control signal that is simply inverted, in which case the traditional generator power output set point is instead treated as an electrical demand set point.

A device control system translates the requested energy level to thermal set points in thermal devices (heaters, air conditioners, freezers, chillers, and the like) such as degrees Fahrenheit or Celsius, to the specific pieces of equipment most likely to most quickly achieve and sustain this level of energy consumption for the longest time. This is based on the consultation of external decision systems that are continuously being provided operational characteristics of the fleet of thermal devices. Power consumption information is computed based on the desired set point and desired hold time for each of the thermal devices. In practice the thermal devices may be of an industrial scale, such as those used in factories and large warehouses. In some cases, the desired hold time for the thermal devices may not be provided and must be inferred. The desired hold time is an estimate of the amount of time needed to operate a thermal device at a different setting.

Periodic monitoring of the operating parameters of the thermal devices is performed and the information is fed in real time to a device control system that uses this data to render predictions of how each piece of equipment will respond to set point changes. Consideration is also given to how long the associated thermal storage can absorb or reject thermal energy at a given electrical energy consumption rate. This is embodied as a saturation level.

Maximum and minimum operating limits as well as predicted maximal rate of change are fed back to the device control system. The device control system is continuously processing new data from the controlled thermal devices and updating the external prediction engines. Deviations from predicted performance, for whatever reason, are handled as they are observed by decreasing the priority of the non-performing device, which causes other devices to backfill this under performance.

The fleet of thermal devices is controlled on a priority basis, and the priorities may be dynamically recalculated based on the new data. In this way, a power utility can achieve a stabilization of the grid, and reduce fluctuations due to demand/supply changes during the course of a day, and the owners of the equipment being so controlled can earn revenue by providing this service.

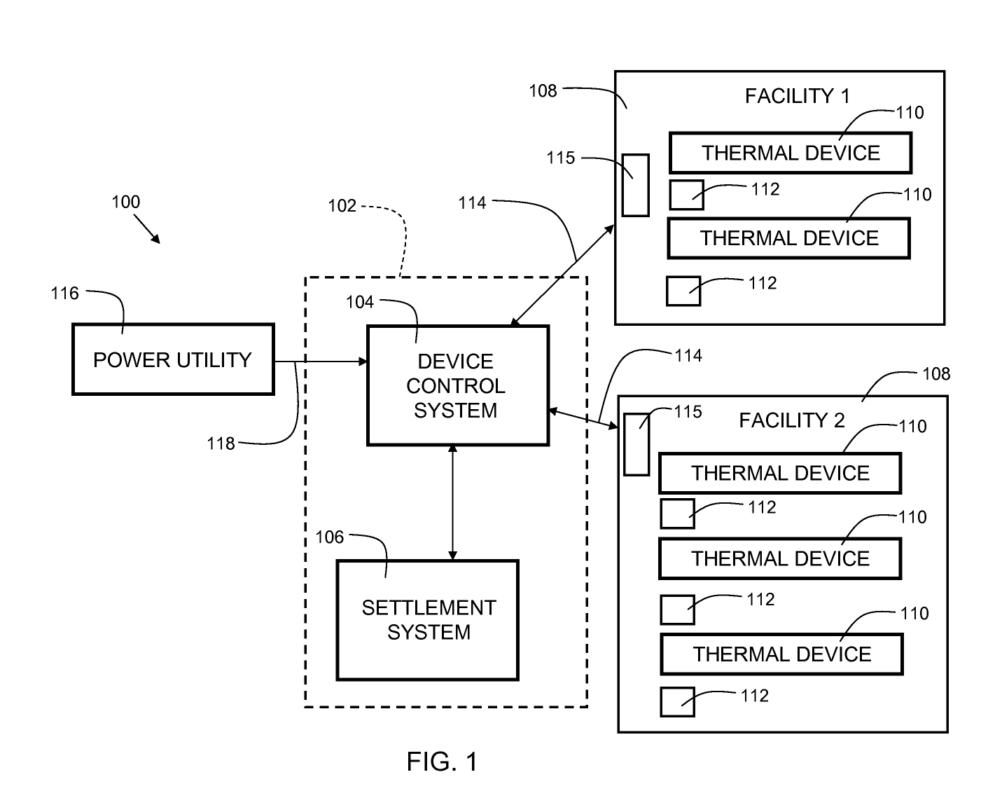

FIG. 1 is a system 100 in accordance with embodiments of the present invention. Power management system 102 may comprise a device control system 104 and a settlement system 106. The device control system 104 receives power adjustment requests from a power utility 116 via communication line 118. In some embodiments, communication line 118 may be a dedicated leased line. The power adjustment requests comprise information regarding a desired power consumption change in response to a predicated electrical grid condition. For example, if it is expected to encounter a peak usage period then the power utility 116 may request the device control system 104 to reduce power consumption. Conversely, if there is excess power on the grid, the power utility 116 may request the device control system 104 to increase power consumption. These changes may be made very quickly, in order to keep the gird in balance while other, more slowly responding loads and generators are dispatched, such as power plants lagging their signal to ramp up or down.

The device control system 104 communicates with a plurality of facilities 108. Typically, these facilities may comprise industrial sites such as factories, smelters, large refrigeration or freezer facilities, or the like. These facilities typically have one or more thermal devices installed. Thermal devices are heating devices such as heaters, or cooling devices such as chillers, refrigeration units, and freezer units. These devices, on an industrial scale, consume large amounts of electrical power. Hence, adjustments to the operating parameters, such as operating temperature, can influence electric grid conditions.

The device control system 104 communicates to each facility via communications channel 114. In embodiments, communications channel 114 may comprise a tunneled network connection. In some embodiments, secure shell (SSH) is used to implement the tunneled network connections over a single persistent network connection. The tunneled connections facilitate faster responses and improved reliability. The communication of device control system 104 may include status requests via a tunneled network connection, such as a request for a current operating temperature. The device control system 104 communicates with a local controller 115 installed at each facility. The local controller 115 communicates with each thermal device 110 (e.g. heating unit or cooling unit) at the facility. The device control system 104 is therefore able to retrieve information about each thermal device 110, and issue commands to control the operation of each thermal device 110. Examples of retrieved information from a thermal device may include, but are not limited to, current operating temperature, minimum operation temperature, maximum operating temperature, saturation level, saturation factor, and recovery factor.

The saturation level pertains to the amount of additional energy a thermal device can consume or conserve. For example, a device such as an industrial process heater may have an operating range of 1100 degrees Celsius to 1300 degrees Celsius, with a nominal operating temperature of 1200 degrees Celsius. In a case where a power utility determines there is too much electricity on the grid, and needs additional power to be consumed, a power adjustment request indicating a need for increased consumption is sent to the device control system 104. The device control system 104 in turn issues a command to a thermal device 110 to increase its operating parameters. In this example, the heater may be able to operate properly at 1300 degrees Celsius for a predetermined duration, and then needs to revert to its nominal temperature after that time. For example, suppose that the heater in the example can be operated at 1300 C for 20 minutes, after which time, it must revert back to the nominal temperature of 1200 C. In that case, the thermal device (heater) is referred to as “fully saturated” after 20 minutes, and needs to be reverted back to its nominal operating temperature.

The saturation factor is proportional to the duration of time it takes a given thermal device operating at its nominal temperature to reach its saturation point. The recovery factor is proportional to the duration of time it takes a given thermal device that is fully saturated to revert to its nominal operating point. The saturation factor and recovery factor are weighting factors that may be used in priority algorithms to determine which thermal devices to cycle in response to power adjustment requests.

In some embodiments, the local controller 115 may further monitor thermal medium temperature data. The thermal medium refers to the temperature of an output material from the thermal device. For example, an industrial chiller may be configured such that water immediately exiting the chiller is to have a temperature ranging from 3 degrees C. to 6 degrees C. Thermal medium sensors 112 may be installed proximal to each thermal device 110 and provide data to local controller 115 which is then accessible by device control system 104. In some embodiments, a thermal margin, based on the thermal medium data, is used as criteria to determine when a thermal device is able to be adjusted. The thermal margin describes how close the thermal medium temperature is to a limit. For example, in the case of the aforementioned industrial chiller, if the thermal medium (water) is currently at 6 degrees C., then the device control system 104 determines that the thermal device can not be adjusted to run any warmer, or the thermal medium temperature will exceed specified limits, and hence the thermal margin is 0. In some embodiments, the data exchange between the device control system 104 and the various thermal devices 110 utilizes (simple object access protocol) SOAP over HTTP.

Note that while two facilities 108 are shown in FIG. 1, in practice, many more than two facilities may be used. Furthermore, a power adjustment request may be handled by adjusting multiple thermal devices. In some cases the multiple thermal devices may be at different facilities. While the examples disclosed herein refer to Celsius temperatures, in practice, another scale, such as, Fahrenheit, Kelvin, or other scale may be used.

An important aspect of embodiments of the present invention is the settlement system 106. The main function of the settlement system is to disburse remuneration to the participating facilities 108 proportional to the amount of adjustment those facilities encountered as a result of device control system 104. The remuneration, which may be in the form of money, power credits, or other types of credits, is awarded to facilities when their thermal devices are adjusted as part of a grid balancing effort. The device control system 104 communicates the amount of adjustment for each thermal device 110. The settlement system reconciles the thermal devices to a facility, and then determines the remuneration amount. Hence, the incentive for facilities to participate in the system is the opportunity to receive remuneration in exchange for allowing some external control of their thermal devices. In some embodiments, the device control system 104 and settlement system 106 may each be implemented as separate computer systems. In other embodiments, the device control system 104 and settlement system 106 may be implemented as a single computer system.

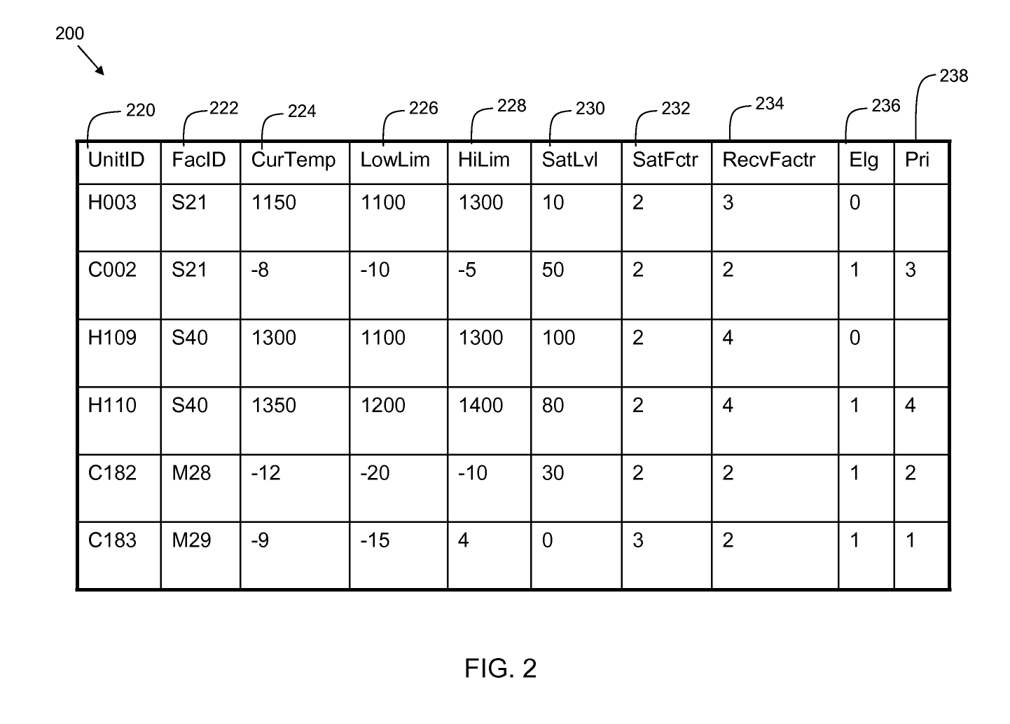

FIG. 2 is exemplary thermal device data 200 for embodiments of the present invention. Data 200 may include information pertaining to each thermal device under control of the device control system 104. The data may include, but is not limited to, a unit identifier (ID) 220, a facility identifier (ID) 222, a current temperature setting 224, a minimum operation temperature 226, a maximum operating temperature 228, a saturation level 230, a saturation factor 232, a recovery factor 234, an eligibility flag 236, and a priority 238. Additionally, a current actual temperature of the thermal medium may be included (such as retrieved from sensors 112 of FIG. 1).

The unit ID 220 is a unique identifier for a particular thermal device. Each thermal device is associated with a facility ID 222. For example, thermal device H003 is associated with facility S21, and thermal device H109 is associated with facility S40. The settlement system is thus able to issue remuneration to facility S40 in response to an adjustment of thermal device H109. Data 200 represents thermal devices that may be entered into a queue of eligible thermal devices. The eligibility flag 236 indicates if a given thermal device can be included in the queue of eligible thermal devices. There are various reasons why a thermal device may not be eligible. If a thermal device is completely saturated, meaning it has consumed or conserved the maximum amount of energy that it can, without compromising operation, then it is no longer eligible, and is removed from the queue and reverted to nominal operating parameters. In the exemplary data of FIG. 2, thermal device H109 is completely saturated (saturation level 230 is 100), and hence, the eligibility flag 236 for thermal device H109 is set to zero. In addition, a facility may opt to manually control a thermal device. For example, after a power adjustment of a heater from 1200 C to 1100 C, the facility may decide to return the heater to its nominal temperature of 1200 C. This results in a facility override request being sent to the device control system 104. In embodiments, this receiving of the facility override request marks the thermal device as ineligible, even if it is not completely saturated. In this way, facilities can still retain full control of their thermal devices for running special processes, or taking them offline for maintenance. In some cases, a facility may schedule maintenance outages in advance, and the maintenance can in turn be factored into capacity estimates that are supplied to the electrical grid operator (e.g. power utility).

The eligible thermal devices are prioritized for selection for control in response to incoming power adjustment requests. The device control system adjusts a subset of the thermal devices based on the priority. A priority 238 is computed for each thermal device. The priority may consider a variety of factors. In one embodiment, the priority is computed as a function of the saturation level. In another embodiment, computing a priority to each of the thermal devices is further based on a saturation factor. In another embodiment, computing a priority to each of the thermal devices is further based on a recovery factor. In another embodiment, computing a priority to each of the thermal devices is further based on a thermal adjustment range. For example, a thermal device with a wide operating range (e.g. 1000 C to 1300 C) may have a higher priority value than a thermal device with a narrow operating range (e.g. 1100 C to 1200 C).

When processing a power adjustment request, the device control system 104 examines the queue of thermal devices to find the devices with the highest priority. Those thermal devices are the first to get adjusted, followed by additional thermal devices as needed to meet the power adjustment request. The power adjustment request may include an amount of power that needs to be consumed or reduced (e.g. in kilowatts). If additional power needs to be consumed, the thermal devices are operated at increased operating parameters, to absorb the energy. For heaters, this typically involves increasing the temperature. For cooling devices, this typically involves decreasing the temperature. Conversely, if additional power needs to be available to the grid, the thermal devices are operated at reduced operating parameters, to absorb less energy. For heaters, this typically involves decreasing the temperature. For cooling devices, this typically involves increasing the temperature.

The device control system aggregates empirical data, as well as formulaic data, pertaining to the relationship between power consumption and a thermal set point for each thermal device. For a particular thermal device, a thermal consumption factor, in kilowatt/hr per degree, describes the relationship. For example, if a particular heater has a thermal consumption factor of 100, then for each degree the heater set point is increased, and additional 100 kilowatts per hour are consumed. The empirical data and formulaic data may be approximations based on manufacturer specifications, or based on actual measurements and experimental data obtained from the thermal device.

In some embodiments, instead of, or in addition to, monitoring a thermal set point, a pressure set point is monitored and adjusted. This may be utilized in equipment such as variable speed blowers in an HVAC system. In such a system, the load of the blower may have a non-linear relationship to the set point. The device control system is configured such that decreases in the pressure set point lower the load more slowly than for increases in the pressure set point. The device control system may take into account how much air has been circulated over a time frame of configurable length (half hour, or hour, for example) and either increase or decrease the dependence on a blower or set of blowers to satisfy the energy set point from the electrical grid and ensure that the proper amount of air is circulated in the facility during operation.

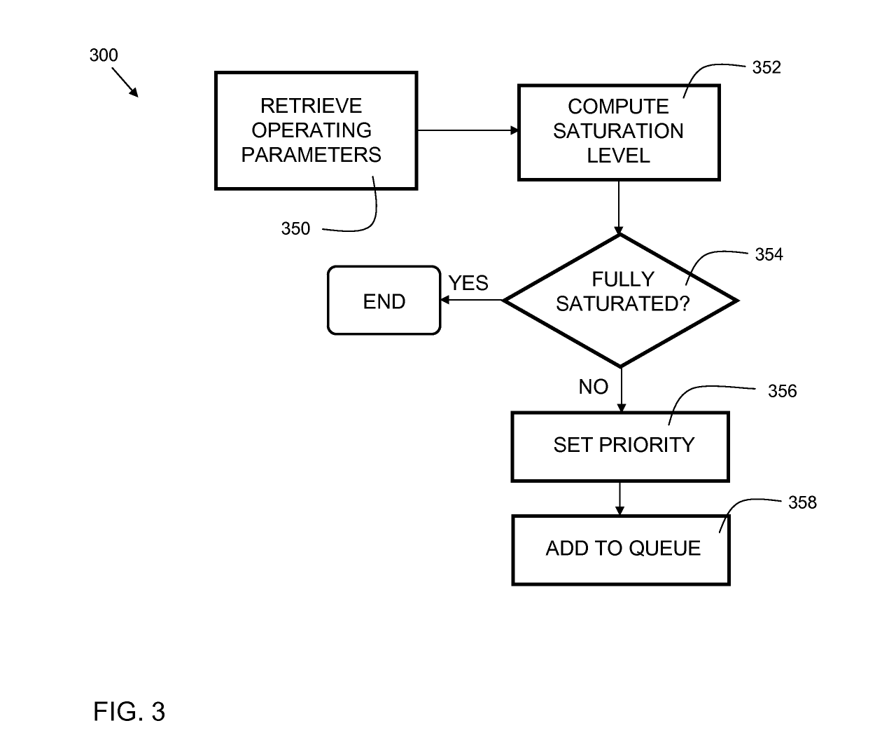

FIG. 3 is a flowchart 300 indicating process steps for adding a thermal device to a queue. In process step 350, the operating parameters of a thermal device are retrieved. These operating parameters may include, but are not limited to, current set temperature, current temperature of the thermal medium, maximum operating temperature, minimum operating temperature, thermal consumption factor, and thermal adjustment range. In process step 352, a saturation level is computed. Computing the saturation level may comprise evaluating how close the current set temperature is to the minimum or maximum temperature, and how close the current set temperature is to the nominal operating temperature of the thermal device. In process step 354, the saturation level is checked to see if the thermal device is fully saturated. In embodiments, the saturation level ranges from zero to 100, with 100 being fully saturated and zero being completely unsaturated. If the thermal device is fully saturated, the process ends without adding the thermal device to the queue. If the thermal device is not fully saturated, a priority is set in process step 356. Setting the priority may comprise computing a priority based on the saturation level. Other factors may also be considered in computing the priority. In some embodiments, the time since the last payment to a facility ID 222 may also be considered. That is, given two thermal devices with similar saturation levels, preference may be given to a thermal device belonging to a facility that has not received remuneration as recently as the other thermal device. In this way, the maximum engagement of the participating facilities is achieved. The thermal device is then added to the queue in process step 358. In one embodiment, the priority P for a given thermal device may be computed as follows:

P=K₁(A)+K₂(B)+K₃(C)+K₄(D)+K₅(E)+K₆(F)

where K₁-K₆ are constants, and
A is the saturation level;
B is the saturation factor;
C is the recovery factor;
D is the time of last payment to the facility to which this thermal device belongs;
E is the thermal consumption factor; and
F is the thermal adjustment range.

Some of the constants may be negative. In some embodiments, the formula to compute the priority may have a non-linear element. Once in the process queue, a thermal device may be selected for adjustment in response to a received power adjustment request.

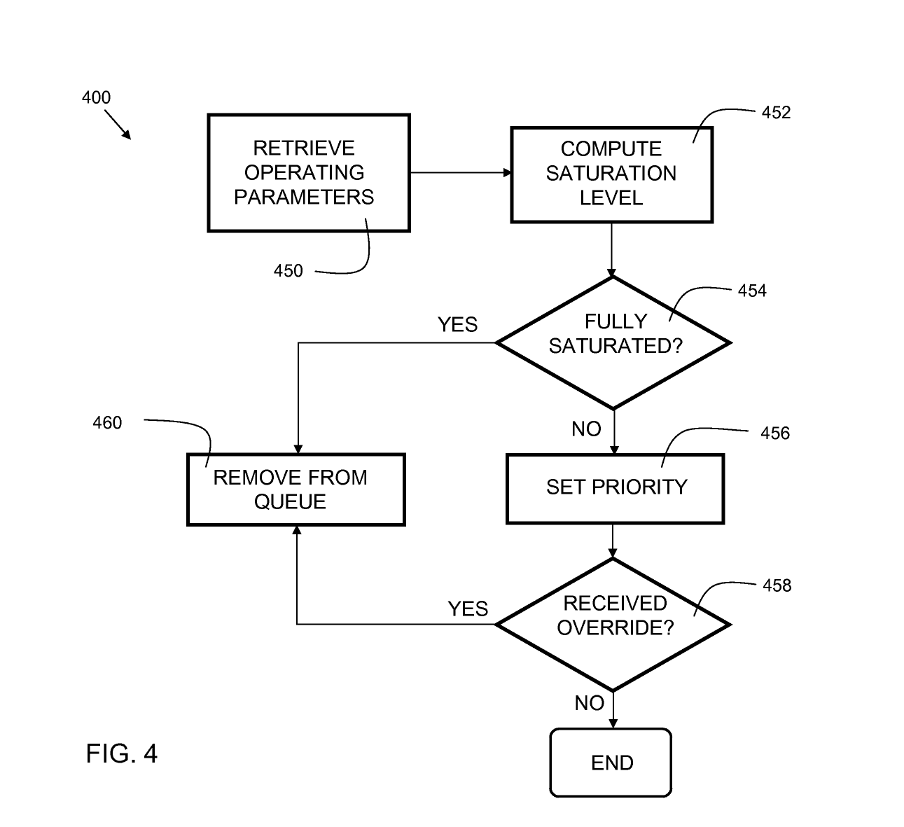

FIG. 4 is a flowchart 400 indicating process steps for removing a thermal device from a queue. In process step 450, the operating parameters of a thermal device are retrieved. These operating parameters may include, but are not limited to, current set temperature, current temperature of the thermal medium, maximum operating temperature, minimum operating temperature, thermal consumption factor, and thermal adjustment range. In process step 452, a saturation level is computed. Computing the saturation level may comprise evaluating how close the current set temperature is to the minimum or maximum temperature, and how close the current set temperature is to the nominal operating temperature of the thermal device. In process step 454, the saturation level is checked to see if the thermal device is fully saturated. If the thermal device is fully saturated, the process proceeds to process step 460, where the thermal device is removed from the queue. If the thermal device is not fully saturated, a priority is set in process step 456. In process step 458, a check is made to see if an override of the thermal set point has occurred. This can happen in a case where a facility adjusts a thermal device or takes it offline, while it was operating at an adjusted thermal set point. If an override is received, the thermal device is removed from the queue in process step 460. If no override is received, then the process ends. Within flowchart 400, the order of some steps may be performed in a different order. Furthermore, the override check may be processed asynchronously, such as in an interrupt-driven manner.

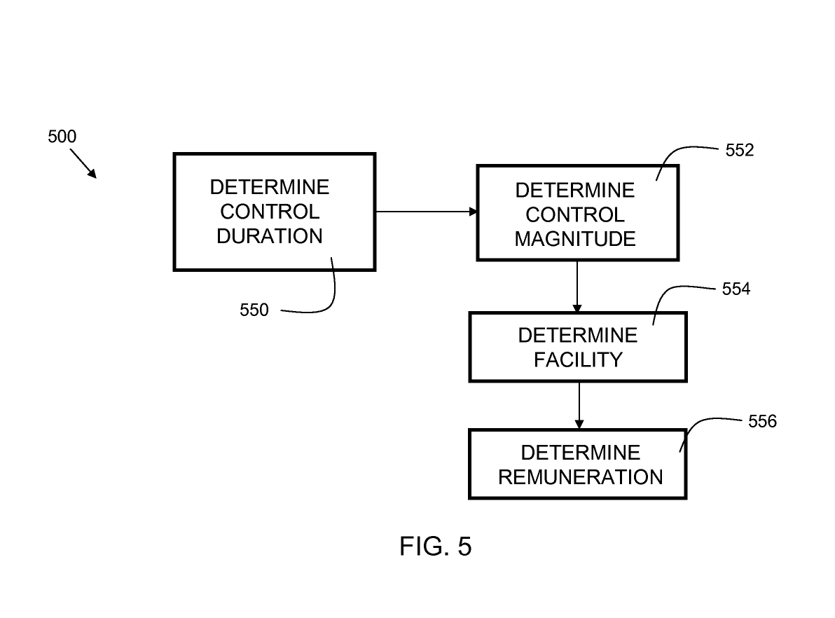

FIG. 5 is a flowchart 500 indicating process steps for performing settlement. In process step 550, a control duration is determined. In some embodiments the duration of control determines the remuneration amount. For example, in one embodiment, the remuneration is computed at a rate of $X/minute/kW of load shift. For example, if the remuneration rate is one cent per minute per kilowatt, and a thermal device was controlled for 40 minutes and changed its load by 1000 kW over that period, then a remuneration of $400 is awarded. Other embodiments may use more complex formulas for determining the remuneration. In process step 552 the magnitude of the load shift is determined. In some embodiments, both the magnitude and duration of the control (load shift) is considered in order to arrive at a remuneration amount. The remuneration may be based on a first multiplier for a positive magnitude, and based on a second multiplier for a negative magnitude. For example, if a thermal device at a facility is adjusted to consume more power, then the first multiplier may correspond to a higher remuneration rate, to offset the higher energy consumption that the facility is facing. Conversely, if a thermal device at a facility is adjusted to consume less power, then the second multiplier may correspond to a lower remuneration rate. In process step 554, the facility to which the thermal device belongs is determined. This may comprise identifying a facility ID for the thermal device. In process step 556 a remuneration is determined, based on factors such as control duration, and optionally, the magnitude of the correction (increased power consumption or decreased power consumption of the thermal devices). The remuneration may be in the form of money, a power utility credit, or other suitable remuneration. The reception of a facility override request truncates the adjustment duration period for a thermal device. Hence, if a thermal device was planned to be set to an increased level for 10 minutes, and after 6 minutes, a facility override request is received, then the adjustment duration period is truncated to 6 minutes. This serves to provide more accurate remunerations.

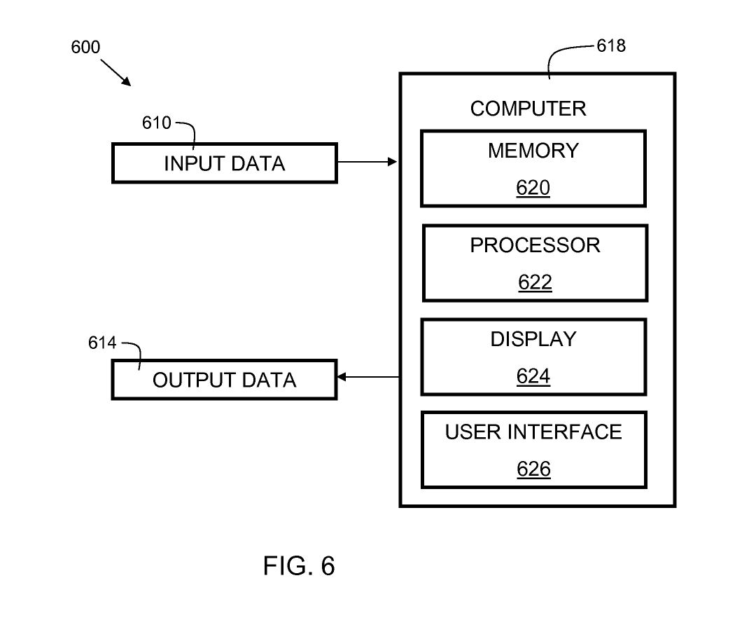

FIG. 6 is a block architecture diagram 600 for a system in accordance with embodiments of the present invention. Block architecture diagram 600 may describe a device control system 104 and/or a settlement system 106 (FIG. 1). System 600 includes a computer 618. Computer 618 comprises memory 620 and a processor 622, which is configured to read and write memory 620. The memory 620 may be a non-transitory computer-readable medium, such as flash, ROM, non-volatile static ram, or other non-transitory memory. The memory 620 contains instructions that, when executed by processor 622, control the various subsystems to operate system 600. Computer 618 may also include a display 624 and a user interface 626 for interacting with the system 600. The user interface 626 may include a keyboard, touch screen, mouse, or the like.

The computer 618 may receive input data 610. For the device control system, input data 610 may include power adjustment requests from a power utility, and current set temperature, current temperature of the thermal medium, maximum operating temperature, minimum operating temperature, thermal consumption factor, and thermal adjustment range from thermal devices. For the settlement system, input data 610 may include control duration information for each thermal device, facility information for each thermal device, and payment schedules for each facility.

The computer 618 may generate output data 614. For the device control system, output data 614 may include commands to control thermal devices, as well as a record of adjustment activity and transactions. For the settlement system, output data 614 may include remuneration values for each facility, as well as a record of adjustment activity and transactions.

As can now be appreciated, embodiments of the present invention provide methods and systems for balancing supply and demand of energy on an electrical grid. Thermal devices such as industrial heaters, air conditioners, freezers, refrigeration units, and chillers have their thermal set points adjusted to control their electrical demand on the basis of the desired level of electrical demand, where the desired electrical demand differs from the demand otherwise required to maintain the system's thermal operating characteristics. This enables adjustment of demand-side electrical equipment (meaning other than local generators, batteries, and flywheels) to correct the balance of supply and demand on the electrical grid.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A method for managing available power in an electrical power grid, comprising:
receiving a power adjustment request;
making an adjustment to operating parameters of one or more thermal devices located in one or more facilities, in response to the power adjustment request; and
disbursing a remuneration to the one or more facilities where at least one thermal device was adjusted.

2. The method of claim 1, wherein making one or adjustments to operating parameters of one or more thermal devices comprises:
determining a saturation level for each thermal device;
assigning a priority to each of the thermal devices based on saturation level; and
adjusting a subset of the thermal devices based on the priority.

3. The method of claim 2, wherein assigning a priority to each of the thermal devices is further based on a saturation factor.

4. The method of claim 3, wherein assigning a priority to each of the thermal devices is further based on a recovery factor.

5. The method of claim 2, further comprising, marking a thermal device as ineligible in response to a facility override request.

6. The method of claim 2, further comprising performing periodic monitoring of the operating parameters of the one or more thermal devices.

7. The method of claim 6, wherein the periodic monitoring of the operating parameters of the one or more thermal devices comprises issuing status requests via a tunneled network connection.

8. The method of claim 6, further comprising retrieving thermal medium temperature data from the one or more facilities, and wherein assigning a priority to each of the thermal devices is further based on the thermal medium temperature data.

9. The method of claim 8, wherein making an adjustment to operating parameters of one or more thermal devices comprises:
computing a desired thermal set point for the one or more thermal devices; and
computing a desired hold time for the one or more thermal devices.

10. The method of claim 9, further comprising, adjusting a pressure set point from the one or more thermal devices.

11. The method of claim 10, further comprising computing power consumption information based on the desired thermal set point and desired hold time for the one or more thermal devices.

12. A method for managing available power in an electrical power grid, comprising:
receiving a power adjustment request;
making an adjustment to operating parameters of one or more thermal devices located in one or more facilities, in response to the power adjustment request;
computing an adjustment duration period for each thermal device belonging to each facility; and
computing a remuneration value based on the adjustment duration period.

13. The method of claim 12, further comprising:
computing magnitude of load shift for each thermal device belonging to each facility; and
computing a remuneration value based on the magnitude of load shift.

14. The method of claim 13, further comprising computing a remuneration value based on a first multiplier for a positive magnitude of load shift, and a second multiplier for a negative magnitude of load shift.

15. The method of claim 12, further comprising truncating the adjustment duration period for a thermal device in response to a facility override request.

16. The method of claim 12, wherein making an adjustment to operating parameters of one or more thermal devices comprises making an adjustment to at least one heating device.

17. The method of claim 12, wherein making an adjustment to operating parameters of one or more thermal devices comprises making an adjustment to at least one cooling device.

18. A system for managing available power in an electrical power grid, comprising one or more processors coupled to non-transitory memory comprising machine instructions, that when executed by the one or more processors, perform functions of:
receiving a power adjustment request;
making one or adjustments to operating parameters of one or more thermal devices located in one or more facilities, in response to the power adjustment request; and
disbursing a remuneration to the one or more facilities in response to each facility where at least one thermal device was adjusted.

19. The system of claim 18, wherein the non-transitory memory further comprises instructions, that when executed by the one or more processors, perform a function of computing a remuneration value based on an adjustment duration period.

20. The system of claim 18, wherein the non-transitory memory further comprises instructions, that when executed by the one or more processors, perform a function of:
computing a magnitude of load shift for each thermal device belonging to each facility; and
computing a remuneration value based on the magnitude of load shift.
